(19) United States
(12) Patent Application Publication
(10) Pub. No.: US 2025/0115287 A1
(43) Pub. Date: Apr. 10, 2025

(54) Steering System and Method for Operating a Steering System

(71) Applicant: Robert Bosch GmbH, Stuttgart (DE)

(72) Inventor: Senthilkumar Thulasidass, Schwaebisch Gmuend (DE)

(21) Appl. No.: 18/904,749

(22) Filed: Oct. 2, 2024

(30) Foreign Application Priority Data
Oct. 9, 2023 (DE) 10 2023 209 792.3

(51) Int. Cl. B62D 5/00; B62D 5/04

(52) U.S. Cl. CPC B62D 5/006; B62D 5/0493

(57) ABSTRACT

A steering system is disclosed. The steering system comprises a control unit, including a feedback actuator for generating a steering resistance and/or a restoring torque to a steering handle and a feedback control unit for controlling operation of the feedback actuator. The steering system comprises a wheel steering angle adjuster mechanically separated from the operating unit, which comprises a steering actuator for changing a wheel steering angle of a vehicle wheel and a steering control unit for controlling operation of the steering actuator. The steering system comprises a transfer unit that communicatively connects the operating unit and the wheel steering angle adjuster to each other. The feedback control unit is provided in a fault operating state in which a fault and/or failure of the steering control unit occurs for controlling the steering actuator.

This application claims priority under 35 U.S.C. § 119 to application no. DE 10 2023 209 792.3, filed on Oct. 9, 2024 in Germany, the disclosure of which is incorporated herein by reference in its entirety.

### BACKGROUND

The invention is based on a steering system according to the generic term of claim 1. Furthermore, the invention relates to a vehicle with such a steering system and a method for operating such a steering system.

Vehicles with conventional steering systems are known from the prior art, in which a steering handle, for example in the form of a steering wheel, is mechanically connected to a wheel steering angle control element in the form of a steering gear via a steering column. In this case, the wheel steering angle adjuster regularly comprises a redundant steering actuator in the form of a servo motor to provide steering support. In the event of a fault, the driver may also provide a further fallback level in order to mechanically steer the vehicle.

Also known are vehicles comprising steer-by-wire steering systems which do not require a direct mechanical connection between a steering handle and the steered vehicle wheels and in which a steering specification is transmitted electrically. A steer-by-wire steering system of this type usually comprises an operating unit with a steering handle and a feedback actuator as well as at least one wheel steering angle actuator that is mechanically separated from the operating unit having a steering actuator for changing the wheel steering angle. Due to the lack of mechanical reach-through, the driver cannot provide an additional fallback level in this case, so that other measures must be taken in the event of a fault.

An obvious possibility in this context is to provide further, additional redundancy, so that a total of at least three separate fallback levels are available. However, such additional redundancy comes at high cost, so other solutions come into focus.

A vehicle system other than the steering system, for example a drive and/or brake system, is therefore known to be used as a further fallback level. Such methods are known, for example from 10 2017 221 289 A1 and DE 10 2022 103 808 A1. However, access to other vehicle systems is not always possible or only possible to a limited extent, so that there is a fundamental need for an internal steering solution.

Based on this, the task of the invention is in particular to provide a steering system with improved properties with regard to operational reliability. The problem is solved by the features of claims 1, 8, and 9, while advantageous embodiments and further embodiments of the invention can be taken from the subclaims.

### SUMMARY

The invention proceeds from a steering system having a control unit, which comprises at least one feedback actuator for generating a steering resistance and/or a restoring torque on a steering handle and at least one feedback control unit for controlling operation of the feedback actuator, with at least one wheel steering angle adjuster mechanically separated from the operating unit, which comprises at least one steering actuator for changing a wheel steering angle of at least one vehicle wheel and at least one steering control unit for controlling operation of the steering actuator, and having a transfer unit, which at least communicatively connects the operating unit and the wheel steering angle adjuster to each other.

It is proposed that the feedback control unit is provided in at least one fault operating state, in which a fault and/or failure of the steering control unit occurs, to control the steering actuator, in particular via the transmission unit. Accordingly, the feedback control unit of the operating unit serves as a back-up control for the wheel steering angle adjuster, wherein the feedback control unit may be provided to completely replace the steering control unit of the wheel steering angle adjuster or cooperate with the steering control unit to control the steering actuator, depending on the fault operating state. This configuration can in particular increase an internal steering operational reliability while providing an advantageously cost-efficient solution.

In the present case, the steering system is intended for use in a vehicle, in particular a motor vehicle, and is designed in particular as a steer-by-wire steering system, in which a steering specification of a driver is advantageously transmitted to the vehicle wheels purely electrically. In this context, the vehicle can generally also comprise an automated and/or autonomous driving mode. The term “operating unit” is in this context understood to mean an input unit that can be operated by a driver in order to control the at least one wheel steering angle actuator. Furthermore, the operating unit can in particular also comprise the steering handle configured as a steering wheel, for example. Moreover, the operating unit may comprise at least one isolating switching unit, advantageously in the form of one or more phase isolating switches, for separating the feedback control unit from the feedback actuator. The feedback actuator is in particular configured as an electric motor and can generally comprise a plurality of sub-machines that are advantageously identically constructed and independent from one another. Furthermore, the feedback control unit may comprise at least one computational logic, at least one power electronic system, for example in the form of a B6-bridge circuit, and at least one driver unit for providing a control voltage and/or a control current for at least one circuit breaker of the power electronic system. In addition, the feedback control unit can comprise a plurality of independent control electronics systems, which are advantageously identical in design and can each comprise computational logic, a power electronics system and a driver unit. The term “wheel steering angle adjuster” is to be understood as an actuator unit which is operatively connected to at least one vehicle wheel, which is intended to transmit a steering specification to the vehicle wheel by changing a wheel steering angle of at least one vehicle wheel, and thereby advantageously control at least one alignment of the vehicle wheel and/or influence a direction of travel of the vehicle. To this end, the wheel steering angle adjuster advantageously comprises at least one steering actuator element, for example in the form of a gear rack, and the steering actuator, in particular one operatively connected to the steering actuator element. Furthermore, the wheel steering angle adjuster may comprise a further isolating switching unit, advantageously in the form of one or more phase isolating switches, for separating the steering control unit from the steering actuator. In addition, the wheel steering angle actuator can in particular be designed as a central actuator and can be associated with at least two, in particular steerable, vehicle wheels or designed as a single wheel actuator and associated with precisely one, in particular steerable, vehicle wheel. The steering actuator is in particular configured as an electric motor and can generally comprise a plurality of further sub-machines that are advantageously identically constructed and independent from one another. Furthermore, the steering control unit may comprise at least one further computational logic, at least one further power electronic system, for example in the form of a B6-bridge circuit, and at least one further driver unit for providing a control voltage and/or a control current for at least one further circuit breaker of the further power electronic system. In addition, the steering control unit can comprise a plurality of independent further control electronic systems, which are advantageously identical in design and can each comprise further computational logic, a further power electronic system and a further driver unit.

Furthermore, a “transmission unit” is in particular to be understood to mean an electrical, optical and/or wireless connection for exchanging data and/or information and/or energy between the operating unit and the at least one wheel steering angle adjuster. In addition, the transmission unit may provide a direct connection between the operating unit and the at least one wheel steering angle adjuster or an indirect connection between the operating unit and the at least one wheel steering angle adjuster, for example via a central computing unit. The transmission unit can be advantageously configured as a BUS connection. Particularly advantageous, the transmission unit may comprise a private CAN and/or an interprocessor communication link between the feedback control unit and the steering control unit. Particularly preferably, the transmission unit is configured such that, in the fault operating state, fault information can be communicated from the wheel steering angle adjuster to the operating unit and the feedback control unit can be requested to take control of the steering actuator or at least one sub-machine of the steering actuator. Moreover, “a fault and/or failure of the steering control unit” is to be understood in particular to mean a fault and/or an at least partially or complete failure of the steering control unit itself and/or of a periphery assembly cooperating with the steering control unit, such as an energy supply, and a fault of the steering control unit caused thereby. The term “provided” is understood in particular as meaning specifically programmed, designed and/or equipped. In particular, the phrase “an object being provided for a specific function” is intended to mean that the object fulfills and/or performs this specific function in at least one application state and/or operating state.

Furthermore, it is proposed that the feedback control unit is provided to control the feedback actuator in the reduced power fault operating state or to adjust the control the feedback actuator. This can in particular can achieve high operational reliability. Furthermore, such a configuration has the advantage that the driver is still able to steer the vehicle in the desired direction, albeit with reduced feedback or without the feedback from the feedback actuator at the steering handle.

Furthermore, it is proposed that the steering system comprises at least one, in particular additional, switching unit for electrically connecting the feedback control unit to the steering actuator. The switching unit is preferably different from the isolating switching unit for separating the feedback control unit from the feedback actuator and from the further isolating switching unit for separating the steering control unit from the steering actuator. Furthermore, the switching unit could generally be integrated into the wheel steering angle adjuster. According to an advantageous configuration, however, it is proposed that the switching unit is integrated in the operating unit and is arranged in terms of circuitry between a power electronic system of the feedback control unit and the transmission unit. Preferably, the switching unit establishes an electrical connection between the feedback control unit and the steering actuator via the transmission unit. Particularly preferably, the feedback control unit, in particular the power electronic system, is electrically connected directly to the steering actuator via the switching unit and the transmission unit. As a result, an advantageous control capability of the steering actuator can be achieved by means of the feedback control unit.

It is also proposed that that the wheel steering angle adjuster comprises at least one detection sensor system, in particular associated with the steering actuator, for detecting at least one operating variable of the steering actuator, wherein the detection sensor system is provided to transmit the operating variable at least in the fault operating state, in particular with sufficient quality, to the feedback control unit, preferably via the transmission unit, and wherein the feedback control unit is provided to control the steering actuator in the fault operating state as a function of the operating variable. Particularly advantageously, the operating variable may be a rotor position signal of the steering actuator. Generally, the operating variable may also be provided redundantly and/or via two redundant channels. As a result, an advantageous synchronization for the control of the steering actuator can be achieved by means of the feedback control unit.

A particularly unobtrusive emergency function, which also satisfies corresponding safety requirements, can in particular be achieved if the feedback control unit is provided to take control of the steering actuator in the fault operating state within a predefined fault tolerance time. In this case, in particular, the feedback control unit, the switching unit, the transmission unit, and/or the steering actuator may be configured accordingly in order to enable control of the steering actuator within the predefined fault tolerance time.

According to a further embodiment, it is proposed that the steering actuator comprises at least two independent steering sub-machines and the steering control unit comprises at least two independent steering control electronic systems, wherein one of the steering control electronic systems is associated with each steering sub-machine, and wherein in the fault operating state, the feedback control unit is provided to replace at least one of the steering control electronic systems or both steering control electronic systems. Accordingly, in this case, the wheel steering angle adjuster provides at least two separate and independent control channels, wherein one of the steering sub-machines and one of the steering control electronic systems is associated with each control channel. As a result, an advantageous redundancy in the wheel steering angle adjuster can be achieved, whereby operational reliability can be further improved.

It is also proposed that the feedback actuator comprises at least two independent feedback sub-machines and the feedback control unit comprises at least two independent feedback control electronic systems, wherein one of the feedback control electronic systems is associated with each feedback sub-machine, and wherein at least one of the feedback control electronic systems is provided in the fault operating state to replace at least a portion of the steering control unit or the entire steering control unit. Accordingly, in this case, the operating unit provides at least two separate and independent control channels, wherein one of the feedback sub-machines and one of the feedback control electronic systems is associated with each control channel. As a result, an advantageous redundancy in the operating unit can be achieved, whereby operational reliability can be further improved.

Furthermore, a first feedback control electronic system is preferably associated with a first steering control electronic system and is intended to replace the first steering control electronics in a first fault operating state, namely, in the event of a fault and/or a failure of the first steering control electronic system, and to take control of a first steering sub-machine of the steering actuator, while a second feedback control electronic system is associated with a second steering control electronic system and is intended to replace the second steering control electronic system in a second fault operating state, namely in the event of a fault and/or a failure of the second steering control electronic system, and to take control of a second steering sub-machine of the steering actuator. To this end, the first feedback control electronic system may be communicatively connected to the first steering control electronic system via a first interprocessor communication link, and the second feedback control electronic system may be communicatively connected to the second steering control electronic system via a second interprocessor communication link. In that case, the feedback control unit may thus be provided to interact with the steering control unit to control the steering actuator and to partially replace the steering control unit. Particularly advantageously, the first feedback control electronic system and the second feedback control electronic system are also provided to replace the first steering control electronic system and the second steering control electronic system in a third failure operating state, namely in the event of a fault and/or failure of the first steering control electronic system and the second steering control electronic system, and to take control of the first steering sub-machine and the second steering sub-machine of the steering actuator. In this case, the feedback control unit is thus intended to completely replace the steering control unit.

In addition, a method for operating the aforementioned steering system is proposed, wherein in at least one fault operating state, in which a fault and/or a failure of the steering control unit is determined, the feedback control unit is used to control the steering actuator. In addition, operation of the wheel steering angle adjuster can be monitored, in particular via the transmission unit. Thus in particular the aforementioned advantages can be achieved. In particular, internal steering operational reliability can be increased while providing an advantageously cost-efficient solution.

The steering system and method for operating the steering system are not intended to be limited to the application and embodiment described hereinabove. In particular, the steering system and method for operating the steering system in order to achieve the functioning described herein can comprise a number of individual elements, components, and units that differs from the number specified herein.

### BRIEF DESCRIPTION OF THE DRAWINGS

Further advantages follow from the description of the drawings hereinafter. Multiple exemplary embodiments of the invention are illustrated in the drawings.

Shown are:

FIGS. 1a-b a vehicle with a steering system designed as a steer-by-wire steering system in a simplified representation,

FIG. 2 a simplified schematic of a structure of the steering system,

FIG. 3 an exemplary flow chart comprising the main method steps of a method for operating the steering system and

FIG. 4 a detailed representation of another exemplary embodiment of a steering system.

### DETAILED DESCRIPTION

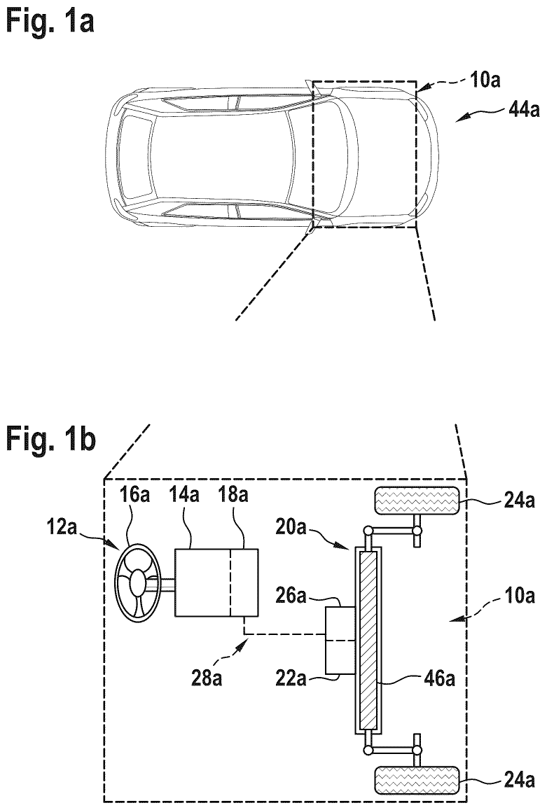

FIGS. 1a and 1b show a simplified illustration of a vehicle 44a which is, e.g., designed as a passenger vehicle comprising a plurality of vehicle wheels 24a and a steering system 10a. The steering system 10a has an operative connection with the vehicle wheels 24a and is intended to influence a direction of travel of the vehicle 44a. Furthermore, the steering system 10a is designed as a steer-by-wire steering system in the present case, in which a steering specification is transmitted electrically to the vehicle wheels 24a in at least one operating state.

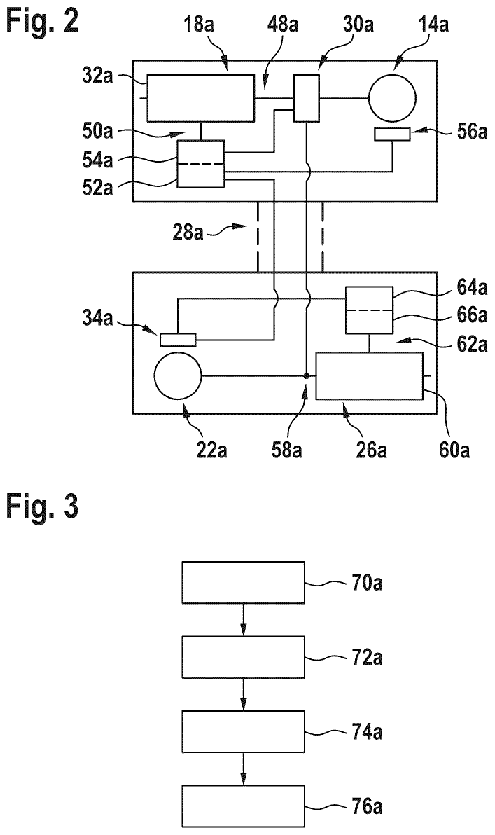

The steering system 10a comprises an operating unit 12a, in particular actuatable by a driver and/or an occupant. The operating unit 12a comprises a steering handle 16a, for example, in the form of a steering wheel, and a feedback actuator 14a which is in particular mechanically coupled to the steering handle 16a. In the present case, the feedback actuator 14a is provided at least in a normal operating state to provide a feedback torque and thereby to generate a steering feel, in particular in the form of a steering resistance and/or a restoring torque on the steering handle 16a. To this end, the feedback actuator 14a comprises at least one electric motor (not explicitly shown) designed in particular as a permanently excited synchronous motor. Furthermore, the operating unit 12a comprises a feedback control unit 18a electrically connected to the feedback actuator 14a for controlling operation of the feedback actuator 14a. A design of the feedback control unit 18a is described below with reference to FIG. 2. A steering handle could alternatively also be designed as a joystick, a steering lever, and/or as a steering ball or the like. A feedback actuator could further comprise a plurality of electric motors.

The steering system 10a further comprises a known wheel steering angle adjuster 20a. The wheel steering angle adjuster 20 is mechanically separated from the operating unit 12a. The wheel steering angle adjuster 20a is purely electrically connected to the operating unit 12a. Furthermore, the wheel steering angle adjuster 20a is, e.g., designed as a central regulator. The wheel steering angle adjuster 20a is operatively connected to at least two of the vehicle wheels 24a, in particular two front wheels, and is intended to convert the steering specification into a steering movement of the vehicle wheels 24a. For this purpose, the wheel steering angle adjuster 20a comprises a steering adjustment element 46a designed (by way of example) as a gear rack, and a steering actuator 22a that cooperates with the steering adjustment element 46a. In the present case, the steering actuator 22a comprises at least one further electric motor (not explicitly shown), designed in particular as a permanently excited synchronous motor, and is intended to provide a steering torque for adjusting the steerable vehicle wheels 24a. Furthermore, the wheel steering angle adjuster 20a comprises a steering control unit 26a electrically connected to the steering actuator 22a to control operation of the steering actuator 22a. A design of the steering control unit 22a is described below with reference to FIG. 2. In principle, a steering system could of course also comprise a plurality of wheel steering angle adjusters, in particular designed as single wheel adjusters, wherein in this case, each wheel steering angle adjuster can comprise a steering actuator and a steering control unit. Furthermore, a steering actuator could comprise a plurality of electric motors or actuators other than a permanently excited synchronous motor.

Moreover, the steering system 10a comprises a transmission unit 28a which at least communicatively connects the operating unit 12a and the wheel steering angle adjuster 20a. The transmission unit 28a is provided to exchange data and/or information between the operating unit 12a and the wheel steering angle adjuster 20a. In addition, in the present case, the transmission unit 28a is provided for the transfer of energy between the operating unit 12a and the wheel steering angle adjuster 20a. In the present case, the transmission unit 28a is configured as an electrical connection line, in particular as a BUS connection. In addition, in the present case, the transmission unit 28a includes, by way of example, a private CAN and an interprocessor communication link between the feedback control unit 18a and the steering control unit 26a.

FIG. 2 shows a principle internal design of the operating unit 12a and the wheel steering angle adjuster 20a.

The feedback control unit 18a includes a power path 48a having a power electronic system 32a. The power electronic system 32a is configured as an output stage, for example a B6-bridge circuit, and on the one hand, has an electrical connection to an energy supply (not shown), for example a vehicle battery, and on the other hand, an electrical connection to the feedback actuator 14a. The power electronic system 32a serves to supply the feedback actuator 14a. In principle, a vehicle can of course also comprise a plurality of energy supply networks, which can also be redundant.

In addition, the feedback control unit 18a comprises a control path 50a having computational logic 52a and a driver unit 54a. For example, computational logic 52a may include at least one processor. Advantageously, the driver unit 54a can be configured as a half bridge driver and/or gate driver. The driver unit 54a has an electrical connection to computational logic 52a on the one hand, and an electrical connection to the power electronic system 32a on the other. The driver unit 54a is provided in order to control at least one circuit breaker (not shown) and advantageously all of the circuit breakers of the power electronic system 32a and to provide a control voltage and/or a control current for the at least one circuit breaker. In principle, a control unit can of course also comprise a plurality of computational logic systems, power electronic systems and/or driver units. In addition, a corresponding power electronic system may comprise different circuit breakers, for example phase breakers and/or rail switches and/or short circuit switches.

Furthermore, the operating unit 12a comprises at least one detection sensor system 56a associated with the feedback actuator 14a for detecting at least one operational variable of the feedback actuator 14a, and preferably multiple operational variables of the feedback actuator 14a. The detection sensor system 56a may be configured as a rotor position sensor, for example, and may be provided for detecting a rotor position signal of the feedback actuator 14a. The detection sensor system 56a has an electrical connection to the feedback control unit 18a, in particular the computational logic 52a. In the present case, the feedback control unit 18a is provided to control the feedback actuator 14a in a normal operating state as a function of the operating variable of the feedback actuator 14a.

The steering control unit 26a comprises a further power path 58a having a further power electronic system 60a. The further power electronic system 60a is configured as an output stage, for example a B6-bridge circuit, and on the one hand, has an electrical connection to a further energy supply (not shown), for example a vehicle battery, and on the other hand, an electrical connection to the steering actuator 22a. The further power electronic system 60a serves to supply the steering actuator 22a. In principle, a vehicle can of course also comprise a plurality of further energy supply networks, which can also be redundant.

In addition, the steering control unit 26a comprises a further control path 62a having further computational logic 64a and a further driver unit 66a. For example, the further computational logic 64a may include at least one further processor. Advantageously, the further driver unit 66a can be configured as a half bridge driver and/or gate driver. The further driver unit 66a has an electrical connection to the further computational logic 64a on the one hand, and an electrical connection to the further power electronic system 60a on the other. The further driver unit 66a is provided in order to control at least one further circuit breaker (not shown) and advantageously all of the further circuit breakers of the further power electronic system 60a and to provide a control voltage and/or a control current for the at least one further circuit breaker. In principle, a wheel steering angle adjuster can of course also comprise a plurality of computational logic systems, power electronic systems and/or driver units.

Furthermore, the wheel steering angle adjuster 20a includes at least one further detection sensor system 34a associated with the steering actuator 22a for detecting at least one operating variable of the steering actuator 22a. The further detection sensor system 34a may be configured as a rotor position sensor, for example, and may be provided for detecting a rotor position signal of the steering actuator 22a. The further detection sensor system 34a has at least one electrical connection to the steering control unit 26a, in particular the further computational logic 64a. In principle, however, an interprocessor communication link between a further detection sensor system and a steering control unit could also be used. In addition, the further detection sensor system 34a in the present case has an electrical connection to the feedback control unit 18a, in particular the computational logic 52a. In the present case, the steering control unit 26a is provided to control the steering actuator 22a in a normal operating state as a function of the operating variable of the steering actuator 22a.

Due to the lack of mechanical reach-through between operating unit 12a and wheel steering angle adjuster 20a, the driver may not provide an additional fallback level, such that other measures must be taken in a fault operating state in which a fault and/or failure of the steering control unit 26a occurs.

In the present case, an internal steering approach is pursued to increase operational reliability. In the present case, the feedback control unit 18a is provided in at least one fault operating state in which a fault and/or failure of the steering control unit 26a occurs to control the steering actuator 22a. In so doing, the feedback control unit 18a is provided to take control of the steering actuator 22a within a predefined fault tolerance time. The feedback control unit 18a therefore serves as a back-up control unit for the wheel steering angle adjuster 20a. Furthermore, the transmission unit 28a is configured such that, in the fault operating state, fault information can be communicated from the wheel steering angle adjuster 20a to the operating unit 12a and the feedback control unit 18a can be requested to take control of the steering actuator 22a. According to the present embodiment, the feedback control unit 18a is provided to completely replace the steering control unit 26a in the fault operating state and to adjust control of the feedback actuator 14a. Alternatively, however, control with reduced power is also possible.

In addition, the steering system 10a comprises a, in particular additional, switching unit 30a for electrically connecting the feedback control unit 18a to the steering actuator 22a. In the present case, the switching unit 30a is integrated into the operating unit 12a and is arranged in terms of circuitry between the power electronic system 32a and the transmission unit 28a. The switching unit 30a is provided to establish an electrical connection between the feedback control unit 18a and the steering actuator 22a via the transmission unit 28a.

Moreover, the detection sensor system 34a is provided to provide the operational variable of the steering actuator 22a via the transmission unit 28a of the feedback control unit 18a, while the feedback control unit 18a is provided in the fault operating state to use and/or take into account this operational variable when controlling the steering actuator 22a.

This configuration can achieve a high level of operational reliability, wherein the driver is still able to steer the vehicle 44a in the desired direction, albeit without feedback from the feedback actuator 14a at the steering handle 16a.

Finally, FIG. 3 shows an exemplary flow chart with the main method steps of a method for operating the steering system 10a.

Method step 70a corresponds to a normal operating state, in particular an error-free state. In this case, the feedback actuator 14a of the operating unit 12a is controlled via the feedback control unit 18a of the operating unit 12a to generate a steering resistance and/or a restoring torque on the steering handle 16a. In addition, the steering actuator 22a of the wheel steering angle adjuster 20a is controlled via the steering control unit 26a of the wheel steering angle adjuster 20a in order to adjust a wheel steering angle of the vehicle wheels 24a, for example, as a function of a steering specification on the steering handle 16a.

In a method step 72a, a fault and/or failure of the steering control unit 26a occurs and consequently a fault operating state. Due to the fault operating state, fault information is transmitted from the wheel steering angle adjuster 20a to the operating unit 12a via the transmission unit 28a and the feedback control unit 18a is requested to take control of the steering actuator 22a.

Subsequently, in a method step 74a, the switching unit 30a is controlled such that the feedback control unit 18a is separated from the feedback actuator 14a and connected to the steering actuator 22a. In principle, two separate switching units could also be used for this purpose. In principle, an isolating switching unit (not shown) of the wheel steering angle adjuster 20a may also be controlled in the same way to separate the steering control unit 26a from the steering actuator 22a.

In a method step 76a, the steering actuator 22a of the wheel steering angle adjuster 20a is then controlled via the feedback control unit 18a of the operating unit 12a, in particular in order to adjust the wheel steering angle of the vehicle wheels 24a, for example, as a function of a steering specification on the steering handle 16a. The takeover by the feedback control unit 18a advantageously occurs within a predefined error tolerance time. The feedback control unit 18a of the operating unit 12a therefore serves in the fault operating state as a back-up control unit for the wheel steering angle adjuster 20a.

The exemplary flow chart in FIG. 3 is only intended to describe an exemplary method for operating the steering system 10a. In particular, individual method steps can also vary, or additional method steps can be added. In this regard, for example, it is contemplated to use a feedback control unit in a fault operating state to control a feedback actuator and to control a steering actuator.

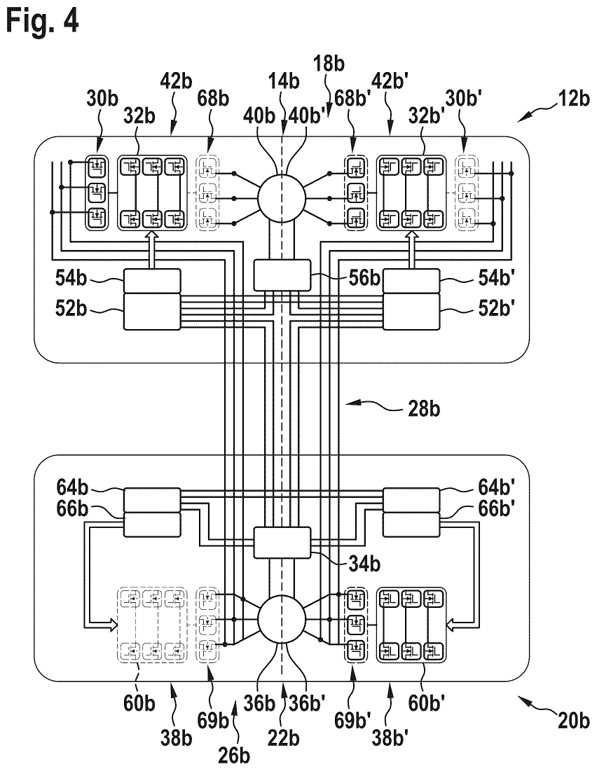

FIG. 4 shows a further exemplary embodiment of the invention. The following description and the drawing are essentially limited to the differences between the exemplary embodiments, wherein reference can also be made in principle to the drawings and/or the description of the other exemplary embodiment, in particular FIGS. 1 to 3, with regard to components with the same designation, in particular with regard to components with the same reference symbols. To differentiate between the exemplary embodiments, the letter a is placed after the reference numerals of the exemplary embodiment in FIGS. 1 to 3. In the exemplary embodiment in FIG. 4, the letter a is replaced by the letter b.

The further exemplary embodiment of FIG. 4 differs from the previous exemplary embodiment at least substantially by a configuration of a feedback actuator 14b and a feedback control unit 18b of an operating unit 12b as well as a steering actuator 22b and a steering control unit 26b of a wheel steering angle adjuster 20b.

In the present case, both the operating unit 12b and the wheel steering angle adjuster 20b each provide two separate and independent control channels.

Accordingly, the feedback actuator 14b includes two independent feedback sub-machines 40b, 40b′ and the feedback control unit 18b includes two independent feedback control electronic systems 42b, 42b′, wherein one of the feedback control electronic systems 42b, 42b′ is associated with each feedback sub-machine 40b, 40b′. In addition, each control channel of the operating unit 12b may comprise an isolating switching unit 68b, 68b′, advantageously in the form of one or more phase breakers, for separating the respective feedback control electronic system 42b, 42b′ from the respective feedback sub-machine 40b, 40b′. The feedback sub-machines 40b, 40b′ and the feedback control electronic systems 42b, 42b′ may be of identical construction. In addition, the feedback control electronic systems 42b, 42b′ each have computational logic 52b, 52b′, a power electronic system 32b, 32b′, and a driver unit 54b, 54b′. Furthermore, the operating unit 12b includes a detection sensor system 56b associated with the feedback actuator 14b for detecting operational variables of the two feedback sub-machines 40b, 40b′.

Moreover, the steering actuator 22b includes two independent steering sub-machines 36b, 36b′ and the steering control unit 26b includes two independent steering control electronic systems 38b, 38b′, wherein one of the steering control electronic systems 38b, 38b′ is associated with each steering sub-machine 36b, 36b′. In addition, each control channel of the wheel steering angle adjuster 20b may comprise a further isolating switching unit 69b, 69b′, advantageously in the form of one or more phase-breakers, for separating the respective steering control electronic system 38b, 38b′ from the respective steering sub-machine 36b, 36b′. The steering sub-machines 36b, 36b′ and the steering control electronic systems 38b, 38b′ are identically constructed. In addition, the steering control electronic systems 38b, 38b′ each have further computational logic 64b, 64b′, a further power electronic system 60b, 60b′ and a further driver unit 66b, 66b′. Furthermore, the wheel steering angle adjuster 20b includes further detection sensor systems 34b associated with the steering actuator 22b for detecting operating variables of the two steering sub-machines 36b, 36b′.

Moreover, in the present case, each control channel of the operating unit 12b includes an additional switching unit 30b, 30b′ for electrically connecting the respective feedback control electronic system 42b, 42b′ to one of the steering sub-machines 36b, 36b′. The electrical connection is in turn made via a transmission unit 28b between the operating unit 12b and the wheel steering angle adjuster 20b.

In this case, a first feedback control electronic system 42b is associated with a first steering control electronic system 38b and is intended to replace the first steering control electronic system 38b in a first fault operating state, namely, in the event of a fault and/or a failure of the first steering control electronic system 38b, and to take control of a first steering sub-machine 36b of the steering actuator 22b, while a second feedback control electronic system 42b′ is associated with a second steering control electronic system 38b′ and is intended to replace the second steering control electronic system 38b′ in a second fault operating state, namely in the event of a fault and/or a failure of the second steering control electronic system 38b′, and to take control of a second steering sub-machine 36b′ of the steering actuator 22b. Thus, in the first fault operating state and in the second fault operating state, the feedback control unit 18b is provided to cooperate with the steering control unit 26b to control the steering actuator 22b and to replace the steering control unit 26b in part, i.e., the first steering control electronic system 38b or the second steering control electronic system 38b′. At the same time, in these cases, the feedback control unit 18b may be provided to control the feedback actuator 14b, more specifically, one of the feedback sub-machines 40b, 40b′, with reduced performance.

In addition, the first feedback control electronic system 42b and the second feedback control electronic system 42b′ are also provided to replace the first steering control electronic system 38b and the second steering control electronic system 38b′ in a third failure operating state, namely in the event of a fault and/or failure of the first steering control electronic system 38b and the second steering control electronic system 38b′, and to take control of the first steering sub-machine 36b and the second steering sub-machine 36b′ of the steering actuator 22b. Thus, in the third fault operating state, the feedback control unit 18b is provided to completely replace the steering control unit 26b, i.e., the first steering control electronic system 38b and the second steering control electronic system 38b′. In addition, in this case, the feedback control unit 18b is provided to adjust a control of the feedback actuator 14b.

FIG. 4 further shows, by way of example, the first fault operating state (indicated by dashed lines and components). In this case, the first feedback control electronic system 42b is provided to replace the first steering control electronic system 38b and take control of the first steering sub-machine 36b of the steering actuator 22b. At the same time, the first feedback control electronic system 42b is provided to adjust control of the first feedback sub-machine 40b in the fault operating state. The second feedback control electronic system 42b′, on the other hand, is further provided to control the second feedback sub-machine 40b′ so that in this case, the feedback actuator 14b is controlled with reduced power. In addition, the second steering control electronic system 38b′ is further provided to control the second steering sub-machine 36b′, such that the first feedback control electronic system 42b and the second steering control electronic system 38b′ cooperate to control the steering actuator 22b in this case.

What is claimed is:

1. A steering system comprising:
a control unit including at least one feedback actuator configured to generate a steering resistance and/or a restoring torque to a steering handle and at least one feedback control unit configured to control operation of the at least one feedback actuator;
at least one wheel steering angle adjuster mechanically separated from an operating unit, the at least one wheel steering angle adjuster including at least one steering actuator configured to change a wheel steering angle of at least one vehicle wheel and at least one steering control unit configured to control operation of the at least one steering actuator; and
a transfer unit configured to at least communicatively connect the operating unit and the at least one wheel steering angle adjuster to each other,
wherein the at least one feedback control unit is configured, in at least one fault operating state in which a fault and/or failure of the at least one steering control unit occurs, to control the at least one steering actuator.

2. The steering system according to claim 1, wherein the at least one feedback control unit is configured to control the at least one feedback actuator in a reduced power fault operating state or to adjust a control of the at least one feedback actuator.

3. The steering system according to claim 1 further comprising:
at least one switching unit configured to electrically connect the at least one feedback control unit to the at least one steering actuator,
wherein the switching unit is integrated into the operating unit and is arranged in terms of circuitry between a power electronic system of the at least one feedback control unit and a transmission unit.

4. The steering system according to claim 1, wherein:
the at least one wheel steering angle adjuster includes at least one detection sensor system configured to detect at least one operating variable of the at least one steering actuator;
the at least one detection sensor system is configured to transmit the at least one operating variable at least in the fault operating state to the at least one feedback control unit; and
the at least one feedback control unit is configured to control the at least one steering actuator in the fault operating state as a function of the at least one operating variable.

5. The steering system according to claim 1, wherein the at least one feedback control unit is configured to take control of the at least one steering actuator in the fault operating state within a predefined fault tolerance time.

6. The steering system according to claim 1, wherein:
the at least one steering actuator includes at least two independent steering sub-machines and the at least one steering control unit includes at least two independent steering control electronic systems, one of the at least two independent steering control electronic systems being associated with each of the at least two independent steering sub-machines; and
the at least one feedback control unit is configured, in the fault operating state, to replace at least one of the at least two independent steering control electronic systems or both of the at least two independent steering control electronic systems.

7. The steering system according to claim 1, wherein:
the at least one feedback actuator includes at least two independent feedback sub-machines and the at least one feedback control unit includes at least two independent feedback control electronic systems, one of the at least two independent feedback control electronic systems being assigned to each of the at least two independent feedback sub-machines; and
at least one of the at least two independent feedback control electronic systems is configured, in the fault operating state, to replace at least one portion of the at least one steering control unit or an entirety of the at least one steering control unit.

8. A motor vehicle comprising:
a steering system including:
a control unit including at least one feedback actuator configured to generate a steering resistance and/or a restoring torque to a steering handle and at least one feedback control unit configured to control operation of the at least one feedback actuator;
at least one wheel steering angle adjuster mechanically separated from an operating unit, the at least one wheel steering angle adjuster including at least one steering actuator configured to change a wheel steering angle of at least one vehicle wheel and at least one steering control unit configured to control operation of the at least one steering actuator; and
a transfer unit configured to at least communicatively connect the operating unit and the at least one wheel steering angle adjuster to each other,
wherein the at least one feedback control unit is configured, in at least one fault operating state in which a fault and/or failure of the at least one steering control unit occurs, to control the at least one steering actuator.

9. A method for operating a steering system, the steering system including (i) a control unit including at least one feedback actuator configured to generate a steering resistance and/or a restoring torque to a steering handle and at least one feedback control unit configured to control operation of the at least one feedback actuator, (ii) at least one wheel steering angle adjuster mechanically separated from an operating unit, the at least one wheel steering angle adjuster including at least one steering actuator configured to change a wheel steering angle of at least one vehicle wheel and at least one steering control unit configured to control operation of the at least one steering actuator, and (iii) a transfer unit configured to at least communicatively connect the operating unit and the at least one wheel steering angle adjuster to each other, the method comprising:
determining at least one fault operating state in which a fault and/or a failure of the at least one steering control unit occurs; and
controlling, in the at least one fault operating state, the at least one steering actuator using the at least one feedback control unit.

10. The steering system according to claim 1, wherein the steering system is a steer-by-wire steering system.
